(19) United States
(12) Patent Application Publication
(10) Pub. No.: US 2006/0266777 A1
(43) Pub. Date: Nov. 30, 2006

(54) Beach buggy case

(76) Inventor: Ching-Ho Huang, Gangshan Township (TW)

Correspondence Address: Ching-Ho Huang, P.O. Box 6-9 717, Tainan, TW

(21) Appl. No.: 11/140,107

(22) Filed: May 31, 2005

(51) Int. Cl. B60R 9/00; B60R 11/00; B60R 7/00

(52) U.S. Cl. 224/401; 224/547

(57) ABSTRACT

A beach buggy base includes a case body, a cap, and three fixing units. The case body has a hollow space in its interior, pivotally combined with the cap with hinges. The fixing units respectively are fixed under the bottom of the case body by adjustable back and forth and right and left. The fixing units respectively consist of a position rail, a clamp and a fastening member, and the clamp has a center hole to fit around a rod of a frame of a beach buggy and then screwed tightly to combine the case on the frame of a beach buggy, with needing no rope or screws or bolts for binding a case on the frame.

### BACKGROUND OF THE INVENTION

1. Field of the Invention

This invention relates to a beach buggy case, particularly to one to be fixed on a frame of a beach buggy, and the case is fixed with adjustable fixing units under its bottom, and then the fixing units are fixed adjustably on the frame at a rear portion of the beach buggy.

2. Description of the Prior Art

If a case for placing things is to be added on a frame of a beach buggy, it has to be bound or fixed stably by means of a rope or fastening members such as bolts or screws. In case a rope is used for binding a case on the frame, it often loosens off to let the case fall off, and if fastening members are used, they are not so easy to fix a case thereon because of little gaps left in the frame.

### SUMMRY OF THE INVENTION

This inventin has been devised to offer a case to be fixed stably on the frame of a beach buggy of any type.

One feature of the invention is a protective U-shaped vertical surface and two grips provided in the case for a back sitter to use for sitting with safety.

Another feature of the invention is two adjustable fixing units for conveniently fixing the case on the frame of a beach buggy.

### BRIEF DESCRIPTION OF DRAWINGS

FIG. 1 is an exploded perspective view of a beach buggy case in the present invention;

FIG. 2 is a perspective view of the beach buggy case in the present invention, showing it being fixed on a frame of a beach buggy;

FIG. 3 is a perspective view of the beach buggy case in the present invention, showing it being fixed on a different-shaped frame of a beach buggy;

FIG. 4 is a perspective view of the beach buggy case with its cap opened in the present invention;

FIG. 5 is a perspective view of the beach buggy case provided with rollers in the present invention;

FIG. 6 is a perspective view of the beach buggy case provided with another smaller case in the present invention;

FIG. 7 is a perspective view of the beach buggy provided with collapsible grips in the present invention;

FIG. 8 is a perspective view of the beach buggy case fixed on the frame of a beach buggy in the present invention; and,

FIG. 9 is a perspective view of the beach buggy case fixed on the roof of a car in the present invention.

### DETAILED DESCRIPTION OF THE PREFERRED EMBODIMENT

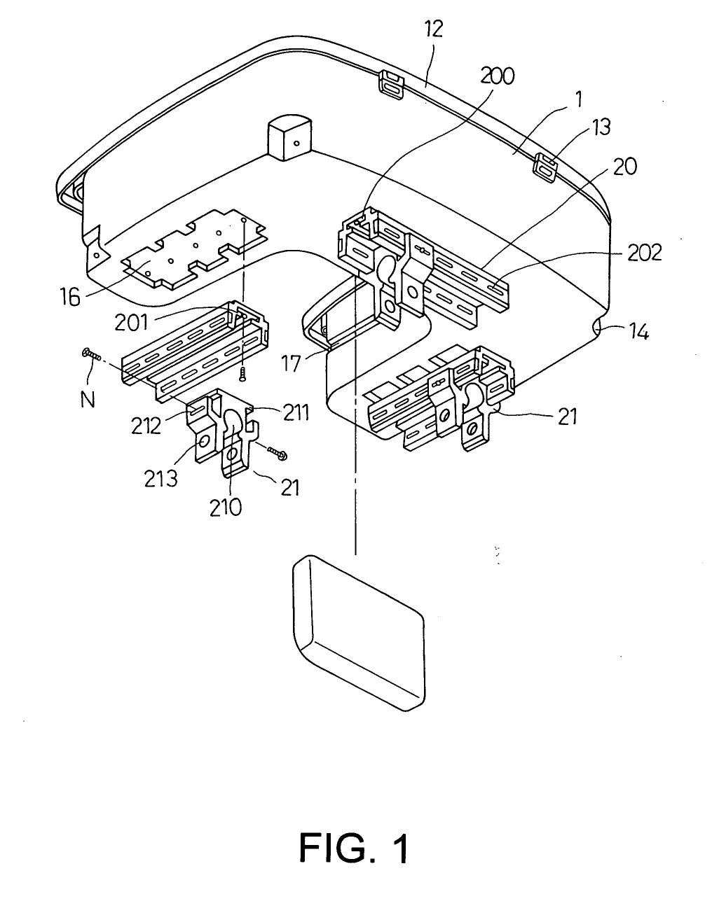

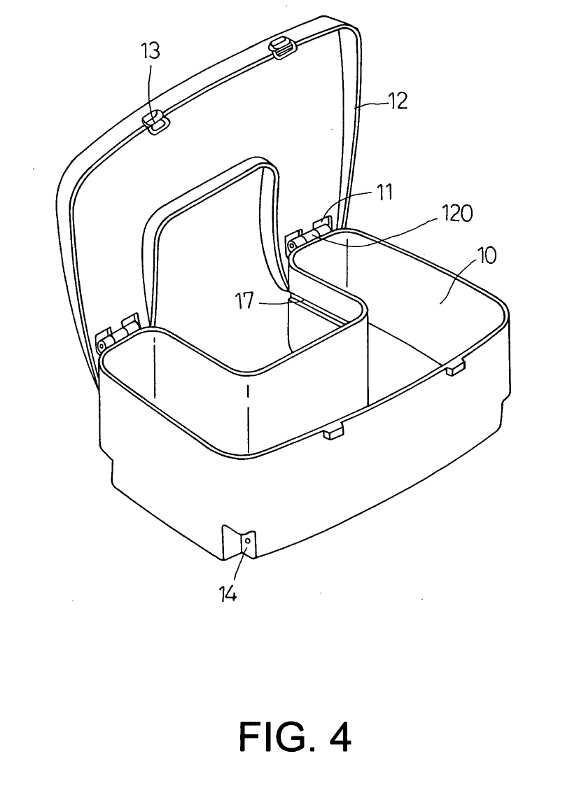

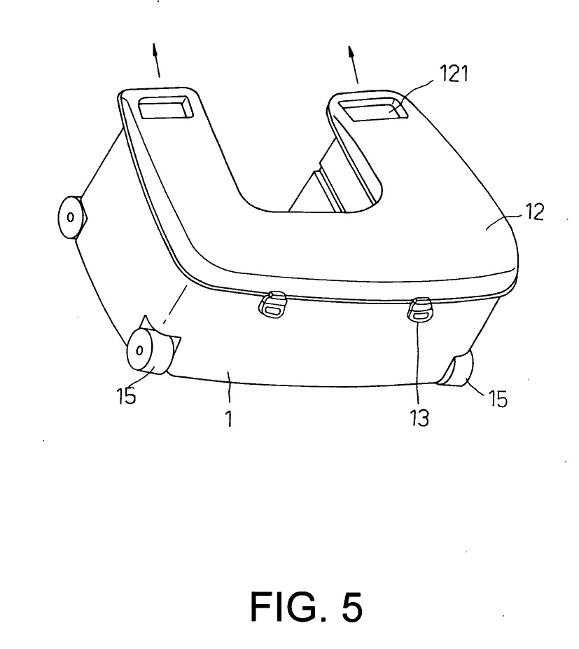

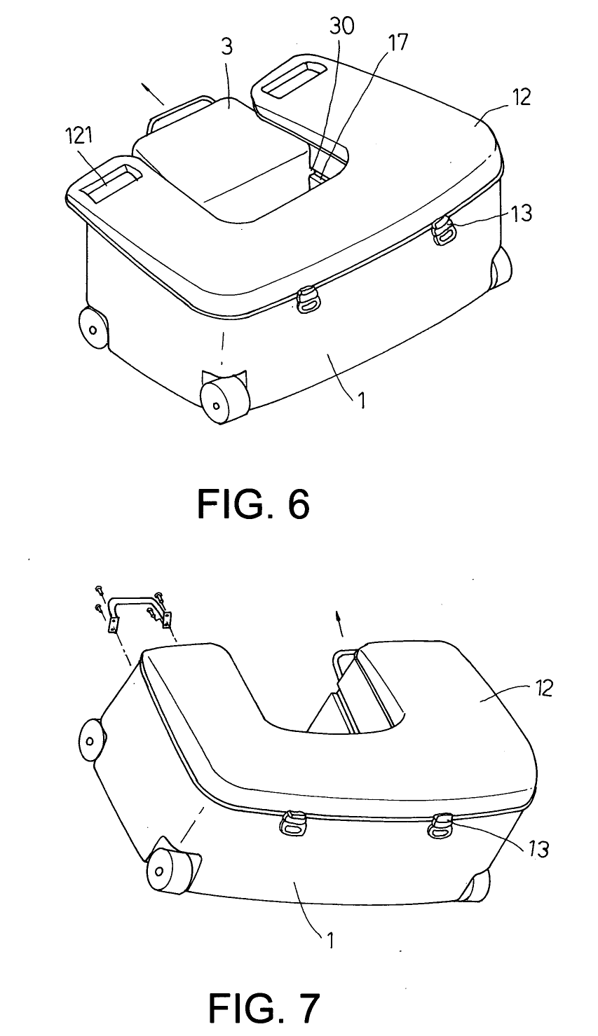

A preferred embodiment of a beach buggy case in the present invention, as shown in FIGS. 1 to 6, includes a case body 1, a cap 12 and three fixing units 2 as main components.

The case body 1 is U-shaped, formed with an hollow space 10 in its interior, two hinges 11 fixed on two rear sides separated by an intermediate opening to combine with two hinges 120 fixed on a rear side of the cap 12 to let the cap 12 to be swung open from or closed on the case body 1. A back seat is positioned at the bottom of the intermediate opening of the case body 1 for a person to sit thereon, with the body of the back sitter positioned in the intermediate opening. The cap 12 further has two hooks 13 spaced apart on a front side to hook with two projections on the front upper edge of the case body 1 to keep the cap 12 stably closed on the case body 1.

Four rollers 15 are collapsibly combined with four roller bases 14 at the four corners of the case body 1 so as to permit the case body 1 with the cap 12 move around on the ground.

The cap 12 can be provided with two gripping holes 121 in two front portions separated by the intermediate opening of the case body 1, for the hands of a back sitter to extend in for grabbing to sit stably on the back seat.

The case body 1 is further provided with two combining recesses 16 spaced apart in the bottom, and a position slot 17 formed horizontally and respectively in two vertical walls facing each other to define the intermediate opening.

The three fixing units 2 respectively consist of a position rail 20, a clamp 21 and a fixing member (N), and two of the fixing units 2 are screwed tightly in the two combining recesses 16 in the bottom of the two parallel portions of the case body 1, and the other of the fixing units 2 is fixed with the bottom of an intermediate portion of the case body 1 with screws.

The position rail 20 has a fitting groove 200, a threaded hole 201 formed in an intermediate vertical wall, and plural adjustable slots 202 spaced apart in a line.

The clamp 21 is nearly inverted-U-shaped, having a center clamping hole 210, a sliding block 211 formed in an upper end above the clamping hole 210, a threaded hole 212 respectively in a L-shaped wall respectively extending outward from two vertical parallel walls and a bolt hole 213 respectively in the two vertical parallel walls to face each other.

The fixing member (N) combines the case body 1 together with the fixing units 2.

An inserting smaller case 3 is combined with the case body 1, having two insert ridges 30 to insert in the position slots 17, for placing miscellaneous things in its interior. But if a person sits on the back seat, the smaller case 3 cannot be used.

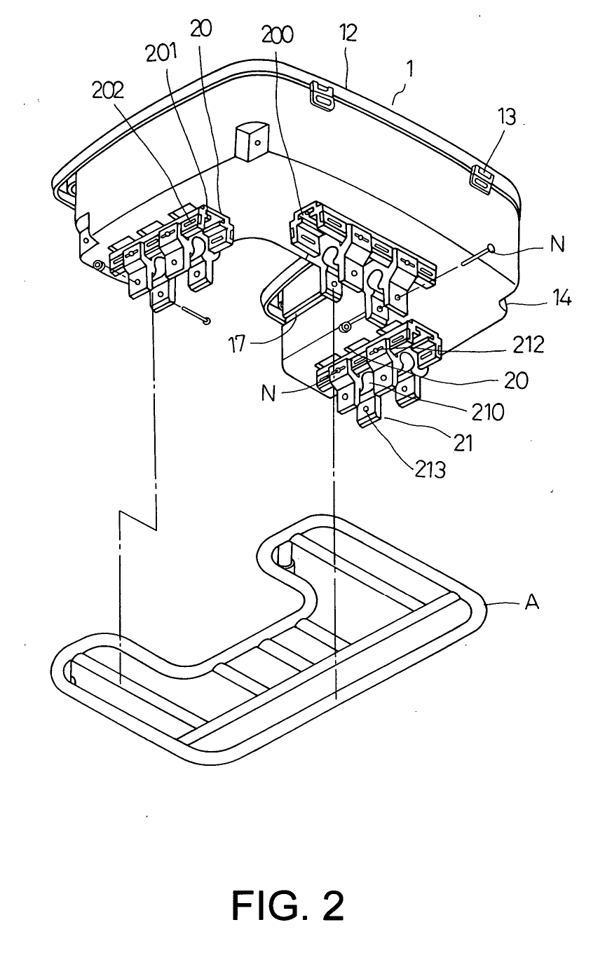

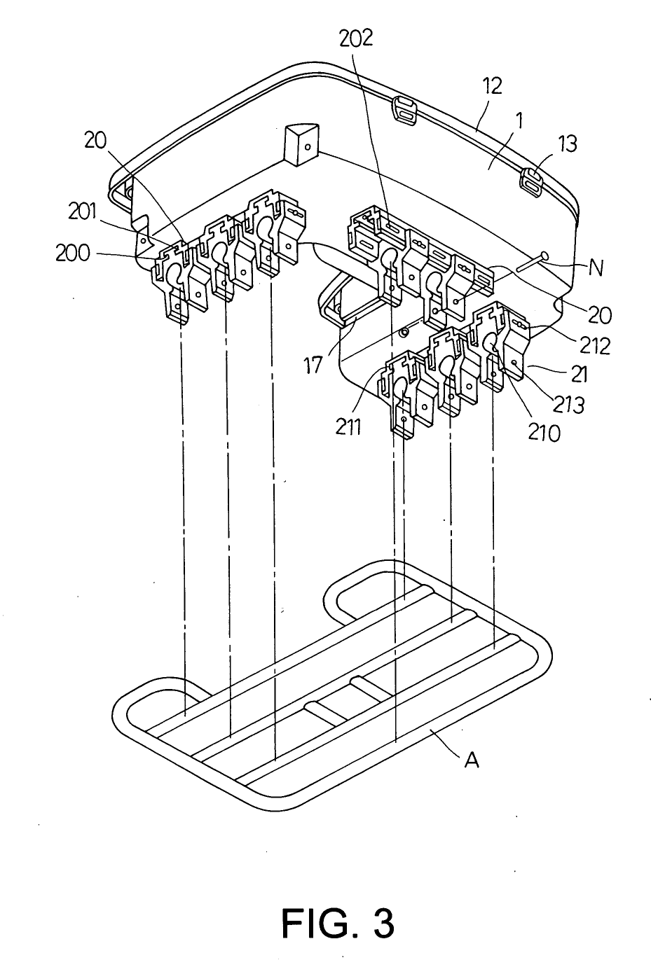

When the case is to be fixed on the frame (A) of a beach buggy, firstly, the fixing units 2 are adjusted in their position according to the frame (A) as shown in FIGS. 2 and 3, with the clamps 21 catching tightly hold of the frame rod of the frame (A) by means of the clamping holes 210 fitting closely around the frame rod. Then a bolt is used to pass through the bolt holes 213 in two vertical parallel walls of said clamp and then screwed tightly with a nut to fix the clamp 21 tightly on the frame (A). Then the case body 1 is combined with the fixing units 2 stably with screws, with the position rails 20 fitting in the combining recesses 16.

The beach buggy case in the invention has the following advantages.

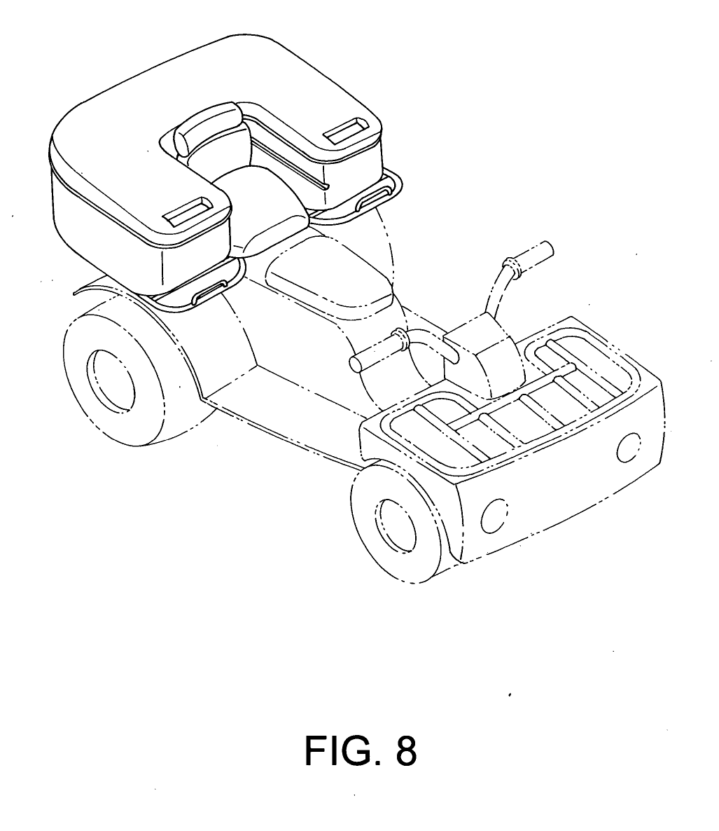

1. It has an inverted-U-shape with two grips 121 for a back sitter to hold to keep the body stably on the back seat, without danger of falling off, as shown in FIG. 8.

2. If the case is to be moved on the ground, the rollers 15 can be combined with the roller bases 14 to let the case move around easily.

3. The fixing units 2 can be adjusted to suit to the structure of the frame (A) of a beach buggy, convenient to fix the case 1 with the frame (A).

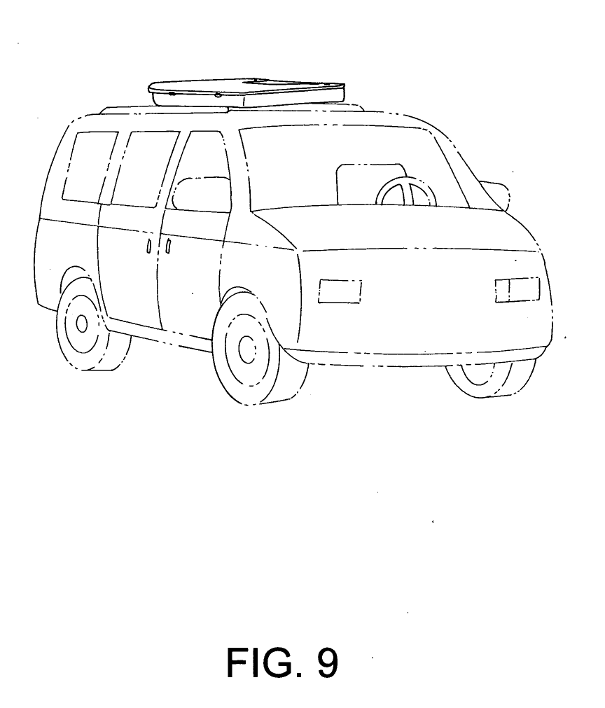

4. The case 1 can be fixed on the roof of an SUV as shown in FIG. 9, easily fixed, by fixing a frame on the roof in advance

5. The insert smaller case 3 can be combined in the intermediate opening of the case body 1 in case of no person sitting on the back seat, by means of the insert ridges 30 inserting in the position slots 17, increasing the space for placing things.

6. The grips can be independently added, as shown in FIG. 7, if necessary.

While the preferred embodiment of the invention has been described above, it will be recognized and understood that various modifications may be made therein and the appended claims are intended to cover all such modifications that may fall within the spirit and scope of the invention.

What is claimed is:

1. A beach buggy case comprising:
a case body with a cap combined with said case body by means of hinges, said case body provided with a hollow space in its interior, said cap having two hooks at a front side to hook with two projections of the case body to keep closed on said case body;
three fixing units respectively fixed under a bottom of said case body with screws, said fix units respectively consisting of a position rail, a clamp and a fastening member, said position rail having a bottom provided with a threaded hole for screwing said position rail with said case body, said position rail further having plural insert grooves in a line in its center, said clamp shaped nearly as an inverted U-shape to have a clamping hole formed in its center for receiving a rod of a frame of a beach buggy, said clamp inserting in said insert grooves, said clamp further having two vertical parallel walls respectively bored with a hole for said fastening member to pass through to position said clamp with said position rail, said position rail fixed under the bottom of said case body;
said case possible to be fixed on a frame of a beach buggy by means of said clamps of said fixing units after said case body is combined with said cap and said fixing units by adjusting the position of said clamps to suit to the structure of said frame.

2. The beach buggy case as claimed in claim 1, wherein two grips are provided at the front side of said cap for a back sitter to hold for keeping the body stable in riding on a beach buggy.

3. The beach buggy case as claimed in claim 1, wherein said clamps respectively have bolt holes in an upper portion for bolts to pass through to fix said clamps tightly with said position rails.
